(19) United States
(12) Patent Application Publication
(10) Pub. No.: US 2024/0036179 A1
(43) Pub. Date: Feb. 1, 2024

(54) COHERENCE RECONSTRUCTION APPARATUS FOR INTERFEROMETRIC MEASUREMENT OF ATMOSPHERIC TURBULENCE

(71) Applicant: RAFAEL ADVANED DEFENSE SYSTEMS LTD., Haifa (IL)

(72) Inventors: Daniel GOLUBCHIK, Kiryat Bialik (IL); David SHWA, Kfar Tavor (IL); Steve ROGERS, Ramat Gan (IL)

(21) Appl. No.: 18/287,006

(22) PCT Filed: Mar. 28, 2022
(86) PCT No.: PCT/IB2022/052842

§ 371 Date: Oct. 15, 2023

(30) Foreign Application Priority Data
Jun. 9, 2021 (IL) 283921

(51) Int. Cl. G01S 7/497; G01S 17/66; G01S 7/4911

(52) U.S. Cl. CPC G01S 7/497; G01S 17/66; G01S 7/4911

(57) ABSTRACT

A coherence reconstruction apparatus generates measurements of atmospheric turbulence from light reflected by a target. The apparatus is in communication with a coherent beam combining (CBC) system which illuminates a target with one or more partially coherent beams from a seed laser. The apparatus includes a variable delay module and a phase shift interferometer (PSI). The delay module uses a measurement of target time-of-flight to form a coherent delayed reference signal from the CBC seed reference laser. The delay module may incorporate an electromagnetically induced transparency medium and/or an electro-optical modulator. The PSI combines the delayed reference optical signal with a target-reflected optical signal to form an interference pattern and to determine one or more turbulence phase correction measurements. The apparatus may include a controller for generating feedback and dynamic tuning signals.

### FIELD OF THE INVENTION

The present invention relates to turbulence compensation in a coherent beam combining (CBC) system, and in particular, to a coherence reconstruction apparatus for interferometric measurement of atmospheric turbulence.

### BACKGROUND OF THE INVENTION

The effectiveness of high power laser systems against non-cooperative targets is severely limited by atmospheric turbulence. One approach to mitigate the effects of turbulence uses deformable mirrors (DM) with a wave front sensor (WFS) and coherent beam combining (CBC) on the targets. However, this approach has been found to be limited to low turbulence conditions, due to the difficulty of reconstructing the phase-front in the WFS in the presence of strong turbulence. The same limitation applies to a CBC system in which multiple laser beams deform the laser wavefront without the use of a DM.

A different approach, which may be more effective at high levels of turbulence, is to measure atmospheric turbulence by analyzing the interference pattern between the beam reflected by a target and a reference beam, for example, in a phase shift interferometer. U.S. Pat. No. 8,575,528, issued Nov. 5, 2013 to Barchers, discloses a coherent phased array beam transmission and imaging system for end-to-end compensation of a plurality of laser beams through a turbulent medium to a non-cooperative target. The reference beam phase is modulated in order to shift the interference pattern and reduce the sensitivity to reflected intensity. The interference pattern is typically measured by a high frame rate camera, and the time-varying atmospheric aberration is deduced from shifts in the interference pattern. This approach is sensitive at low intensity levels of the reflected beam, and avoids problems such as wave-front stitching from phase gradients when using a Wave-Front Sensor (WFS), such as a Shack-Hartmann sensor. In this approach, it is necessary for the coherence length of the laser illumination to be longer than twice the distance to the target. In some applications, the required coherence length may be on the order of many kilometers.

In order to achieve high laser power, one must suppress non-linear effects, such as Stimulated Brillouin Scattering (SBS), typically by broadening the laser linewidth or enlarging the laser spectral width. However, this has the effect of greatly reducing the laser coherence length, or coherence time; for example, a 1 kW fiber laser may have a coherence length of only a few millimeters after SBS suppression. Thus the need to suppress non-linear effects in order to achieve a high laser power is in conflict with the requirement of a long coherence length, which is needed to compensate atmospheric turbulence by phase shift interferometry.

Pseudo-Random Binary Sequence (PRBS) modulation has been used in optical telecommunications in order to increase the power of a fiber laser, while decreasing its coherence length in a deterministic manner. The PRBS sequence is typically generated from a linear feedback shift register consisting of n bits, producing a pseudo-random pattern of 2ⁿ-1 (nonzero) binary numbers. The time duration of each bit is the reciprocal of the shift register clock frequency.

### SUMMARY OF THE INVENTION

The invention provides a coherence reconstruction apparatus for interferometric measurement of atmospheric turbulence when illuminating a target at long range with a high-power CBC system.

According to one aspect of the presently disclosed subject matter, there is provided a coherence reconstruction apparatus in communication with a coherent beam combining (CBC) system which illuminates a target with one or more encoded and at least partially coherent beams which propagate through a turbulent atmosphere. The apparatus includes a variable delay module which receives a seed laser reference signal from the CBC system and a target time-of-flight (TOF) measurement, and a phase shift interferometer (PSI) which receives a target-reflected optical signal from the CBC system. The variable delay module generates a delayed reference optical signal which is coded; the PSI combines the target-reflected optical signal with the delayed reference optical signal to form an interference pattern; and the PSI determines at least one turbulence phase correction measurement from the interference pattern.

According to some aspects, the delayed reference optical signal includes at least a portion of a binary-phase code and/or a poly-phase code modulation.

According to some aspects, the binary-phase code modulation is a Pseudo-Random Binary Sequence (PRBS) modulation.

According to some aspects, the poly-phase code modulation is a generalized Barker code or a Frank code.

According to some aspects, a clock frequency of the code modulation is at least one gigahertz.

According to some aspects, the interferometer comprises one or more photo-detectors.

According to some aspects, the interferometer comprises a photodiode array.

According to some aspects, the target-reflected optical signal is provided by a receiver in the CBC system.

According to some aspects, the apparatus further includes a controller which transmits a turbulence correction feedback signal to the CBC system.

According to some aspects, the apparatus further includes a controller which transmits dynamic tuning signals to the variable delay module.

According to some aspects, the seed laser reference signal is encoded.

According to some aspects, the seed laser reference signal is not encoded and the delay module includes a code delay module.

According to some aspects, the TOF measurement is provided by a target range tracker and/or a Target-in-the-Loop tracking system.

According to some aspects, the delay module includes an electromagnetically induced transparency (EIT) medium and/or a pump laser.

### BRIEF DESCRIPTION OF THE DRAWINGS

The invention is herein described, by way of example only, with reference to the accompanying drawing.

FIG. 1 is a schematic drawing of an exemplary coherence reconstruction apparatus, according a first embodiment the invention.

FIG. 2 is a schematic drawing of an exemplary coherence reconstruction apparatus, according a second embodiment the invention.

### DETAILED DESCRIPTION OF THE PREFERRED EMBODIMENTS

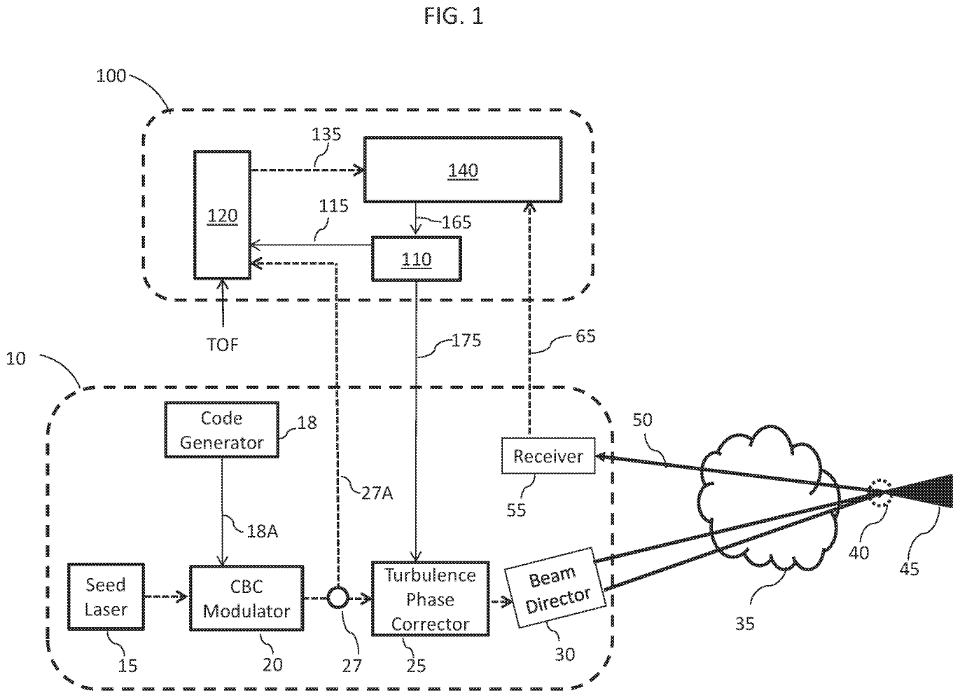

FIG. 1 shows a schematic drawing of an exemplary coherence reconstruction apparatus 100, according to a first embodiment of the invention. Apparatus 100 communicates with CBC system 10 and includes a variable delay module 120 and a phase shift interferometer (PSI) 140. The apparatus receives as input:
(a) a seed laser reference signal 27A provided by the CBC system;
(b) a target-reflected optical signal 65 provided by the CBC system; and
(c) a target time-of-flight (TOF) measurement
   The variable delay module uses inputs (a) and (c) to generate a delayed reference optical signal 135. PSI 140 combines signal 135 with input (b) to form an interference pattern, from which one or more turbulence phase correction measurements 165 are determined.

The following sections describe each of the signals and signal processing functions in detail.

### Seed Laser Reference Signal

This signal is provided by the CBC system 10. The CBC system generates and directs a multiplicity of coherent laser beams to illuminate a generally non-cooperative target 45. For clarity of presentation, only one illumination beam is shown in the exemplary CBC system of FIG. 1, with the understanding that the coherence reconstruction apparatus of the invention may operate independently and in parallel on more than one beam of a CBC system.

Seed laser 15 injects coherent light into a CBC electro-optical modulator 20. Modulator 20 receives a phase modulation code signal 18A from a code generator 18. The phase modulation corresponds to a deterministic code, such as a binary-phase or a poly-phase code. Code generator 18 typically includes a linear feedback shift register having a shift register clock frequency which is, for example, greater than or equal to 1 gigahertz (GHz).

PRBS is one example of a binary-phase code. A PRBS code consists typically of a repeating sequence of 2n-1 binary numbers each having (n) bits, where a bit represents a phase shift of zero or pi radians. The sequence includes all nonzero binary numbers arranged in a randomized, but deterministic, order. The value of integer (n) is typically greater than or equal to eight, in order to provide sufficient signal-to-noise ratio for coherence reconstruction.

Poly-phase codes include, for example, generalized Barker codes, Frank codes, and a variety of other modulation codes which are known to those skilled in the art of signal processing.

The encoded optical beam propagates from modulator 20 to beamsplitter 27, along the propagation path indicated by the dashed arrow in FIG. 1. The beamsplitter redirects a portion of the encoded optical signal power to form the seed laser reference signal 27A. Beamsplitter 27 may be implemented, for example, using fiber-optic splitters, reflective optics, and/or diffractive optical elements. Note that in the embodiment shown in FIG. 1, the seed laser reference signal 27A is already encoded with the modulation code.

### Target-Reflected Optical Signal

This signal is provided by the CBC system 10. In FIG. 1, beamsplitter 27 transmits a second optical beam along the path indicated by the dashed arrow entering into a turbulence phase corrector 25. The latter receives a turbulence correction feedback signal 175 from the coherence reconstruction apparatus 100, and applies an optical phase correction to the CBC output beams so that they combine in-phase (constructively) at the illumination spot 40 formed on the target surface.

The turbulence-corrected optical beam enters a beam director 30, which steers the beam with high angular accuracy, typically on the order of a few micro-radians. The beam is focused, together with other illumination beams provided by the CBC system, onto an illumination spot 40 on the surface of the target 45. A portion of the energy impinging on the target forms a reflected beam 50, whose phase and intensity are distorted by time-varying turbulent perturbations as the beam propagates through moving air masses in a turbulent region 35 of the atmosphere.

A CBC receiver 55, which typically includes a telescopic optical system with an entrance aperture, receives a portion of the light in the reflected beam 50. At target ranges of several kilometers, the power of the received light may be 9 to 12 orders of magnitude smaller than the illumination power emitted by the CBC system. The receiver sends a target-reflected optical signal 65, indicated by a dashed arrow, to the PSI 140 of the coherence reconstruction apparatus 100. Signal 65 is typically a fiber-optic or a free-space optical signal.

### Target Time-of-Flight (TOF) Measurement

This measurement is typically provided by a target range tracker or a Target-in-the-Loop (TIL) system (not shown in FIG. 1). The TOF is equal to twice the target range, R, divided by the speed of light, c, in the atmosphere. For example, with c=3×10⁸ meters/sec and R=3000 meters, the TOF is equal to 2R/c=20×10⁻⁶ sec, or microseconds.

Continuing with the description of the coherence reconstruction apparatus 100 of FIG. 1, the variable delay module 120 receives the seed laser reference signal 27A and the target TOF measurement. An exemplary embodiment for module 120 incorporates a coherent control art device, which includes an electromagnetically induced transparency (EIT) medium and a pump laser to tune the group velocity of the seed laser reference signal 125 in the medium. Module 120 generates a delayed reference optical signal 135.

The PSI 140 receives signal 135 and the target-reflected optical signal 65, both of which are typically of fiber-optic or free-space optical signals. The PSI forms an interference pattern between the two signals 65 and 135 using one or more photo-detectors, such as for example, a photodiode array. In the absence of atmospheric turbulence, the two signals would be in phase, to within a constant phase offset, and there would be no interference pattern; the presence of an interference pattern is caused solely by atmospheric turbulence. PSI 140 converts the interference pattern into one or more turbulence measurement signal(s) 165. Generally, the use of interferometry greatly improves the signal-to-noise ratio of the turbulence measurement signals, especially when the reflected beam passes through a strong turbulence regime, characterized by large fluctuations in the intensity of the reflected beam.

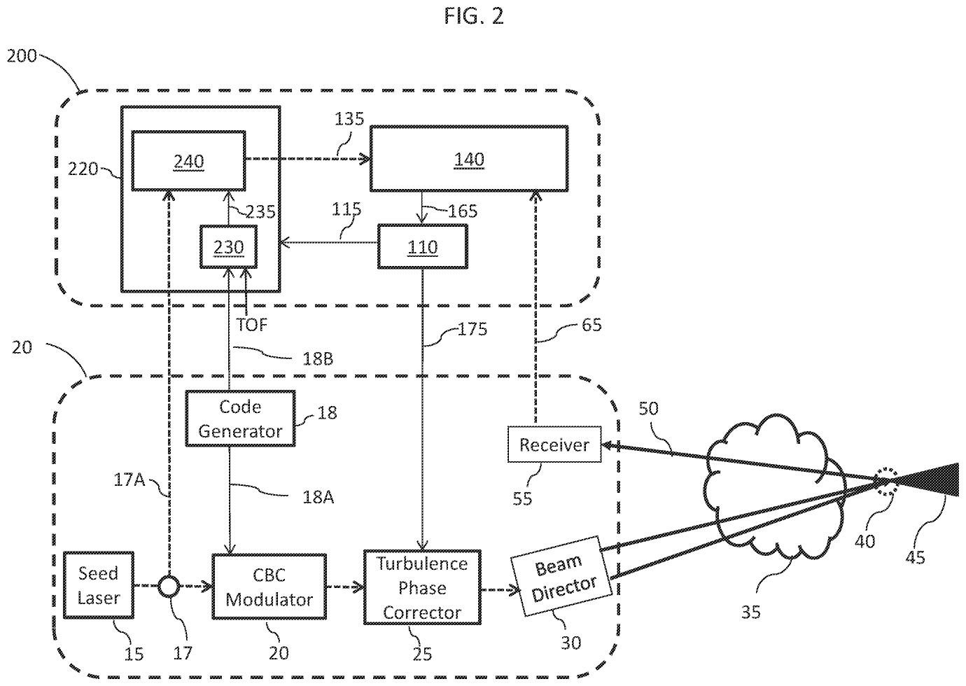

FIG. 2 shows a schematic drawing of an exemplary coherence reconstruction apparatus 200, according to a second embodiment of the invention. This embodiment differs from that in FIG. 1 in the following respects.

In CBC system 20 of FIG. 2, a beamsplitter 17 is positioned between the seed laser 15 and the CBC modulator 20, which is different from the placement of beamsplitter 27 in FIG. 1. The beamsplitter 17 sends an unencoded seed laser reference signal 17A to the coherence reconstruction apparatus 200.

In apparatus 200, a variable delay module 220 includes a code delay module 230 and an optical delay module 240. Code delay module 230 receives a phase modulation code signal from code generator 18 and introduces a time delay equal to the received target TOF measurement in order to form a delayed code signal 235. Delay module 230 uses, for example, a digital-to-analog converter (DAC) or a voltage-controlled oscillator (VCO) followed by an RF amplifier, to generate a delayed code signal 235.

Optical delay module 240 receives the signal 235 and the unencoded seed laser reference signal 17A. Variable delay module 240 typically generates an analog signal representing the code modulation, using componentry similar to that used in CBC modulator 20, but with the additional input of delayed code signal 235. The analog signal drives an electro-optical (EO) modulator, such as a lithium niobate EO modulator. The latter generates the delayed reference optical signal 135, which is sent to the PSI 140.

Additional embodiments of the reconstruction apparatus 100 and/or the reconstruction apparatus 200 include a controller 110, which fulfills any one of several functions. One function is to generate the turbulence correction feedback signal 175 and to send it to the turbulence phase corrector 25 of the CBC system. A second function of controller 110 is to generate and transmit dynamic tuning signals 115 to the variable delay module. The tuning signals typically contain TOF offsets that are determined by analyzing incremental shifts in the interference pattern formed in the PSI.

Although the embodiments of the present disclosure have been described within the context of binary-phase and poly-phase modulation, the principles of the present disclosure may be equally applicable to implementations that use other types of phase modulation.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A coherence reconstruction apparatus in communication with a coherent beam combining (CBC) system which illuminates a target with one or more encoded and at least partially coherent beams which propagate through a turbulent atmosphere, the apparatus comprising:
a variable delay module which receives a seed laser reference signal from the CBC system and a target time-of-flight (TOF) measurement; and
a phase shift interferometer (PSI) which receives a target-reflected optical signal from the CBC system;
wherein
the variable delay module generates a delayed reference optical signal which is coded;
the PSI combines the target-reflected optical signal with the delayed reference optical signal to form an interference pattern; and
the PSI determines at least one turbulence phase correction measurement from the interference pattern.

2. The apparatus of claim 1 wherein the delayed reference optical signal comprises at least a portion of a binary-phase code and/or a poly-phase code modulation.

3. The apparatus of claim 2 wherein the binary-phase code modulation is a Pseudo-Random Binary Sequence (PRBS) modulation.

4. The apparatus of claim 2 wherein the poly-phase code modulation is a generalized Barker code or a Frank code.

5. The apparatus of claim 2 wherein a clock frequency of the code modulation is at least one gigahertz.

6. The apparatus of claim 1 wherein the interferometer comprises one or more photo-detectors.

7. The apparatus of claim 1 wherein the interferometer comprises a photodiode array.

8. The apparatus of claim 1 wherein the target-reflected optical signal is provided by a receiver in the CBC system.

9. The apparatus of claim 1 further comprising a controller which transmits a turbulence correction feedback signal to the CBC system.

10. The apparatus of claim 1 further comprising a controller which transmits dynamic tuning signals to the variable delay module.

11. The apparatus of claim 1 wherein the seed laser reference signal is encoded.

12. The apparatus of claim 1 wherein the seed laser reference signal is not encoded and the delay module comprises a code delay module.

13. The apparatus of claim 1 wherein the TOF measurement is provided by a target range tracker and/or a Target-in-the-Loop tracking system.

14. The apparatus of claim 1 wherein the delay module comprises an electromagnetically induced transparency (EIT) medium and/or a pump laser.
